(19) United States
(12) Patent Application Publication
(10) Pub. No.: US 2008/0251005 A1
(43) Pub. Date: Oct. 16, 2008

(54) Meter device

(76) Inventor: Hitoshi Koike, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 12/081,192

(22) Filed: Apr. 11, 2008

(30) Foreign Application Priority Data
Apr. 13, 2007 (JP) 2007-106494

(51) Int. Cl. G01D 11/24

(52) U.S. Cl. 116/305

(57) ABSTRACT

A meter device includes a dial having a display design, a case which is disposed on one side of the dial, and supports the dial, a substrate which is disposed on a side of the case opposite to the dial, the substrate being provided with an electric component for display driving of the dial, a plurality of engagement claws each of which is raised toward the substrate from an outer circumferential portion of the case, and is formed to be elastically deformable in inward and outward sides of the case, and a claw part which projects in an inward direction of the case from a leading end part of the engagement claw, and has an engaging face engaging with an outer circumferential edge portion of the substrate from a side of the substrate opposite to the case side, so as to fasten the substrate to the case.

### PRIORITY CLAIM

The present application is based on and claims priority from Japanese Patent Application No. 2007-106494, filed on Apr. 13, 2007, the disclosure of which is hereby incorporated by reference in its entirety.

### BACKGROUND OF THE INVENTION

1. Field of the Invention

The present invention relates to a meter device for use in a vehicle, in particular, to a technique which fastens a substrate onto a case.

2. Description of the Related Art

Conventionally, in a meter device for use in, for example, a vehicle, a substrate on which electrical components such as a movement for driving an indicting needle and a light source for illuminating a dial from the rear side are mounted is provided in the rear side of the dial (meter back side).

As a technique which fastens the substrate onto the case for supporting the dial, there is known a technique which fastens onto the case a cover provided in the substrate on the meter back side in a state such that the substrate is held by the cover (refer to, for example JP-H11-72359A).

Moreover, there is known an economically advantageous technique in which the outer circumferential edge portion of a substrate is engaged with a claw part of an engaging claw rising from a case, so as to fasten the substrate onto the case without the need for the cover.

However, the technique which engages the substrate with the claw part of the engaging claw has the following problems because it is difficult to make uniform the thickness of the substrate over the entire substrate.

More particularly, if the thin part of the substrate is inserted into the claw part of the engaging claw, a space is generated between the substrate and the claw part of the engaging claw, causing looseness between the substrate and the claw part. For this reason, there may be a case which causes abnormal noise due to the vibration when driving. On the other hand, the thick part of the substrate can not be inserted into the claw part of the locking claw, resulting in an engagement error.

### SUMMARY OF THE INVENTION

The present invention has been made in view of the above problems, and an object of the present invention is to provide a meter device in which a substrate is reliably engaged with an engagement claw without causing looseness, and an engagement error is prevented from occurring even if a substrate having an uneven thickness is used.

In order to achieve the above object, an aspect of the present invention relates to a meter device including a dial having a display design; a case which is disposed on one side of the dial, and supports the dial; a substrate which is disposed on a side of the case opposite to the dial, the substrate being provided with an electric component for display driving of the dial; a plurality of engagement claws each of which is raised toward the substrate from an outer circumferential portion of the case, and is formed to be elastically deformable in inward and outward sides of the case; and a claw part which projects in an inward direction of the case from a leading end part of the engagement claw, and has an engaging face engaging with an outer circumferential edge portion of the substrate from a side of the substrate opposite to the case side, so as to fasten the substrate to the case, wherein the engagement claw is provided with a contact face which separates toward the case from the engaging face, so as to form between the engaging face and the contact face a space into which the outer circumferential edge portion of the substrate is insertable, and has contact with the outer circumferential edge portion of the substrate from the case side of the substrate, the contact face inclining from the inward side of the case toward the outward side of the case in a direction away from the case.

Preferably, the claw part of the engagement claw is provided with a guide face which inclines from the inward side of the case toward the outward side of the case in the direction away from the case, and the outer circumferential edge portion of the substrate, which has contact with the guide face when inserting the outer circumferential edge portion of the substrate into the space, is provided with a convex portion which has point-contact with the guide face or has line-contact with the guide face.

Preferably, the claw part of the engagement claw is provided with a concave part which follows the engaging face at the outward side of the case, and dents from the inward side of the case toward the outward side of the case in the direction away from the case, the concave part being disposed to face to the contact face.

Preferably, the concave part is formed by a face parallel to the contact face of the substrate.

Preferably, the contact face is provided in a supporting convex part which projects to the inward side of the case from the engagement claw, the claw part of the engagement claw projects to the inward side of the case closer than the supporting convex part, and the engaging face is disposed inward of the case closer than the contact face, a part of the outer circumferential edge portion of the substrate is provided with a cutout which is cut inward of the case from the outer circumferential edge portion, and an edge part of the cutout is engageable with the engaging face of the engagement claw, and is disposed to be contactable with the contact face.

Preferably, a pair of the claw parts is disposed in each of the engagement claws, the pair of the claw parts being disposed to separate in a circumferential direction of the case, and the contact face is substantially disposed in a center position of the pair of claw parts in the circumferential direction of the case.

### BRIEF DESCRIPTION OF THE DRAWINGS

These and other features, aspects, and advantages of the present invention will become better understood with regard to the following description, appended claims, and accompanying drawings.

FIG. 1 is a sectional view illustrating a main section of a meter device A according to an embodiment of the present invention.

FIG. 2 is a sectional view illustrating a main section of the meter device A according to the embodiment of the present invention.

FIG. 3 is an exploded perspective view illustrating the meter device A according to the embodiment of the present invention.

FIG. 4 is an exploded perspective view illustrating a lower case 4 and a substrate 5 of the meter device A as seen from a back side direction of a meter according to the embodiment of the present invention.

FIG. 6 is a perspective view illustrating the main section of the base 5 of the meter device A according to the embodiment of the present invention.

FIG. 7 is a perspective view illustrating the main section of the lower case 4 of the meter device A as seen from the back side direction of the meter according to the embodiment of the present invention.

FIG. 8 is a perspective view illustrating a state in which the substrate 5 is fastened to the lower case 4 of the meter device A according to the embodiment of the present invention.

FIGS. 9A-9D are functional explanatory views illustrating, in order from FIG. 9A to FIG. 9D, procedures of attaching the substrate 5 onto the lower case 4 in the meter device A according to the embodiment of the present invention.

FIG. 10 is a sectional view illustrating a main section according to another example of the present invention.

FIG. 11 is a sectional view illustrating a main section according to another example of the present invention.

### DETAILED DESCRIPTION OF THE PREFERRED EMBODIMENTS

Hereinafter, a preferred embodiment of the present invention will be described with reference to the accompanying drawings.

A meter device according to the preferred embodiment of the present invention includes a dial (3) having a display design, a case (4) which is disposed on one side of the dial (3), and supports the dial (3), a substrate (5) which is disposed on a side of the case (4) opposite to the dial (3), the substrate (5) being provided with an electric component for display driving of the dial (3), a plurality of engagement claws (46) each of which is raised toward the substrate (5) from an outer circumferential portion of the case (4), and is formed to be elastically deformable in inward and outward sides of the case (4), and a claw part (46b) which projects in an inward direction of the case from a leading end part of the engagement claw (46), and has an engaging face (46d) engaging with an outer circumferential edge portion (56) of the substrate (5) from a side of the substrate (5) opposite to the case (4) side, so as to fasten the substrate (5) to the case (4), wherein the engagement claw (46) is provided with a contact face (46f) which separates toward the case (4) from the engaging face (46d), so as to form between the engaging face (46d) and the contact face (46f) a space (47) into which the outer circumferential edge portion (56) of the substrate (5) is insertable, and has contact with the outer circumferential edge portion (56) of the substrate (5) from the case (4) side of the substrate (5), and the contact face (46f) inclines from the inward side of the case (4) toward the outward side of the case (4) in a direction away from the case (4).

### Embodiment

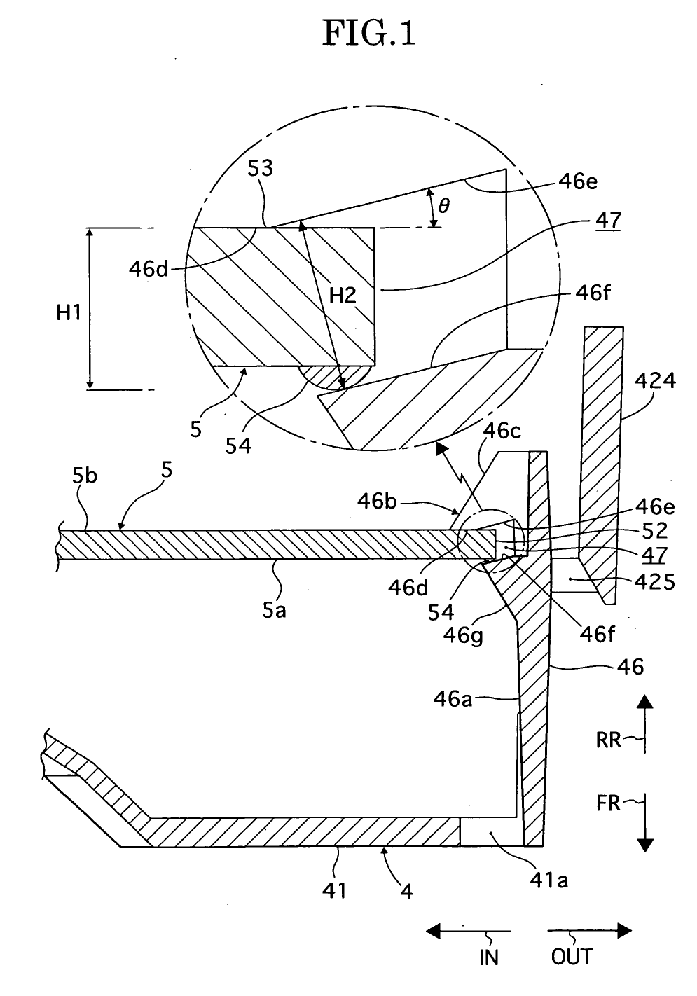

Hereinafter, a meter device according to the embodiment of the preferred embodiment of the present invention will be described with reference to FIG. 1 to FIG. 9D.

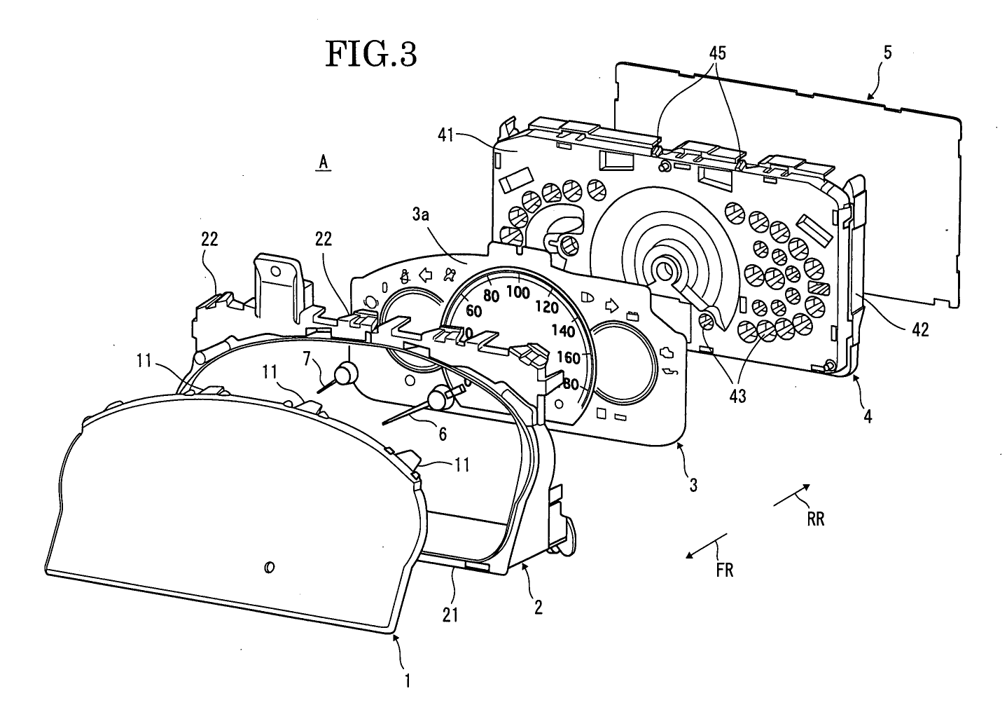

A meter device A of the embodiment is attached in a meter cluster provided in an instrument panel (not shown) for a vehicle, and includes, in order from a front direction side of a meter illustrated by the arrow FR, a surface cover 1, an upper case 2, the dial 3, the lower case 4, and the substrate 5, as illustrated in FIG. 3.

In the meter device A, the upper case 2 engages with the lower case 4 while holding the dial 3 therebetween. The side of the upper case 2 in the front direction of the meter is covered by the transparent surface cover 1, and the substrate 5 is fastened to the back side direction of the meter (arrow RR direction) of the lower case 4.

The surface cover 1 is made of a transparent resin board, and has in the outer circumference thereof a plurality of engaging claws 11 each of which is integrally formed to project to the back side direction of the meter. The engaging claws 11 engage with the upper case 2, so that the surface cover 1 is fastened to the upper case 2.

The dial 3 is made of a transparent resin material such as polycarbonate, and has a surface 3a including a display design such as a scale and a picture symbol, which are indicators of an indicating needle of a meter. The display design is formed by a coating material such as transmissible white paint. A black coating material such as black paint having a light-shielding property is also painted on parts of the surface 3a other than the display design part. Thereby, when illuminating the dial 3 from the back side, the scale and the character symbol emit light.

The upper case 2 and the lower case 4 are made of hard resin. The dial 3 is held between the upper case 2 and the lower case 4, such that the surface 3a faces the front direction of the meter, which faces a driver (not shown).

The upper case 2 is provided with a vertical wall 21 which surrounds the outer circumference of the dial 3. The outer circumference of the upper case 2 is provided with a plurality of engaging claws 22 each of which projects to the back side direction of the meter so as to engage with the lower case 4.

The lower case 4 includes a supporting board 41 which supports the rear face of the dial 3, and an outer wall 42 which projects to the back side direction of the meter from the outer circumference of the supporting board 41.

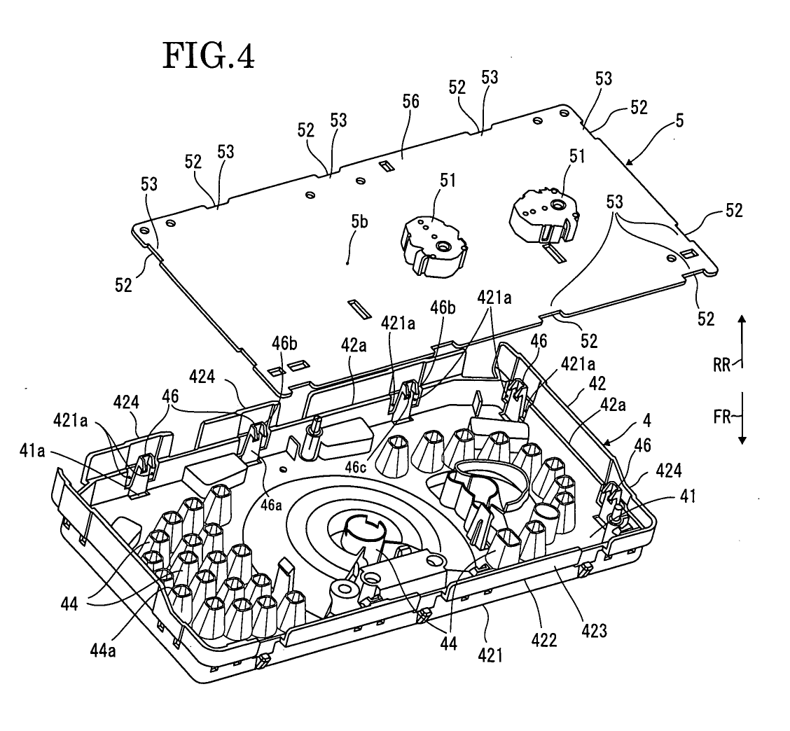

The supporting board 41 has a plurality of holes 43 thorough which the driving shafts of movements 51 (refer to FIG. 4) mounted on the substrate 5 penetrate, respectively, and also the light from a light source (not shown) mounted on the substrate 5 passes toward the front direction of the meter.

Moreover, the outer circumferences of these holes 43 are formed with tubular convex portions 44, respectively, each of which projects to the back side direction of the meter, as illustrated in FIG. 4. Leading end faces 44a of these convex portions 44 are supporting faces for the central part of the substrate 5.

The outer wall 42 of the lower case 4 is formed with a plurality of projections 45 each of which projects to the outer circumferential direction so as to be engaged with the engaging claw 22 of the upper case 2.

In addition, indicating needles 6, 7 illustrated in FIG. 3 rotate by the driving shafts of the movements 51.

The substrate 5 has a substantially rectangular-shaped plate made of hard resin such as epoxy resin. The substrate 5 is provided with the above-described movements 51, light source, and a circuit which drives those. An outer circumferential edge portion 56 of the substrate 5 is engaged with the engagement claws 46 (refer to FIG. 4) integrally formed in the lower case 4, so that the substrate 5 is fastened onto the lower case 4.

Hereinafter, a structure which locks the substrate 5 to the lower case 4 will be described.

At first, regarding the substrate 5, as illustrated in FIG. 4, in the outer circumferential edge portion 56 of the substrate 5, the portions which are engaged with the engagement claws 46, respectively, are provided with cutouts 52 each having a substantially rectangular shape.

In a rear face 5b of the substrate, which is the face of the substrate 5 on the back side direction side of the meter, the edge portion along each of the cutouts 52 is an engaged portion 53 with which the engagement claw 46 engages.

On the other hand, in a front face 5a of the substrate, which is the face of the substrate 5 on the front face direction side of the meter, the portion which is the rear side of the engaged portion 53 is provided with guide projections 54 which extend along the cutout 52, as illustrated in FIG. 5.

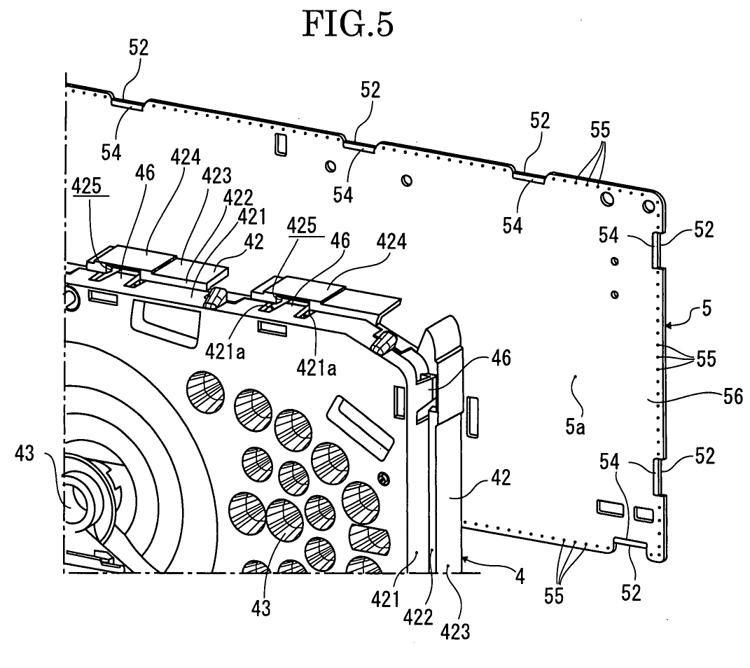

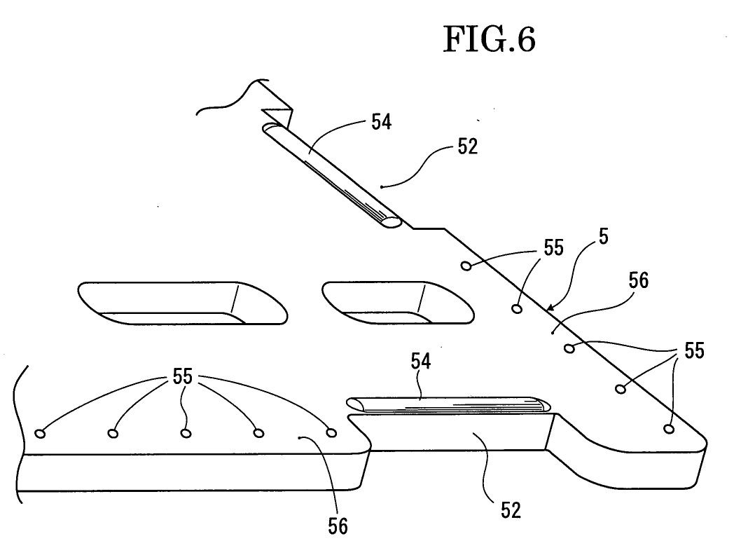

These guide projections 54 extend along the cutout 52 and have a predetermined circular arc sectional shape (refer to FIG. 1) as illustrated in FIG. 6. The guide projections 54 are formed by means of solder in a soldering process which connects the electrical components and the circuits provided on the substrate 5.

Moreover, a plurality of contact convex portions 55 is formed in line along the outer circumferential edge of the front face 5a of the substrate. The contact convex portions 55 are located in the portions except for the portions where the cutouts 52 are formed. Similar to the guide projection 54, each of the contact convex portions 55 is formed by solder in the soldering process. As described later, each of the contact convex portions 55 has, as seen from the front direction of the meter, a circular form of less than 1 mm in diameter, so as to have point-contact with the lower case 4, and has a circular arc sectional shape.

Next, the structure of the lower case 4 will be described.

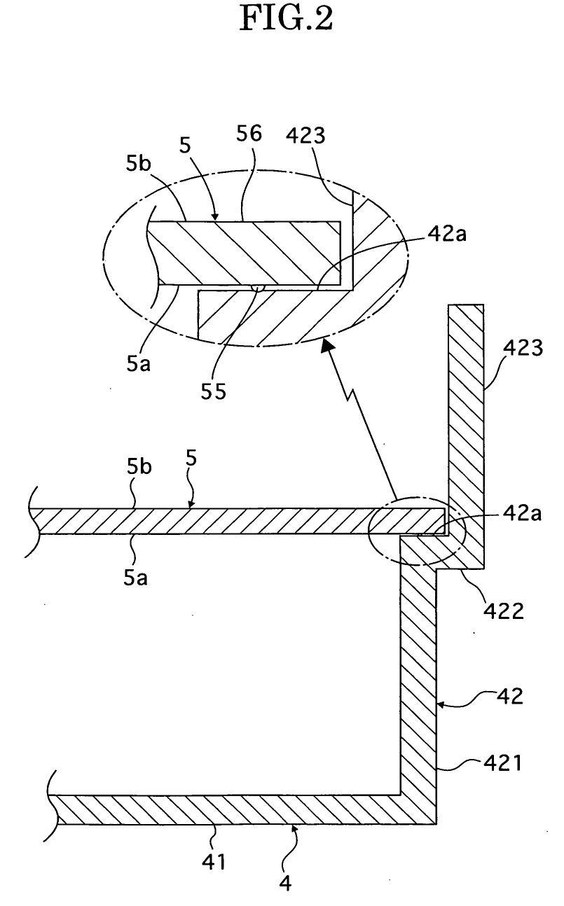

As illustrated in FIGS. 4, 5, the outer wall 42 of the lower case 4 includes an outer wall base 421 which rises to the back side direction of the meter from the supporting board 41, a step portion 422 which extends outwardly from the outer wall base 421, and an outer wall leading end portion 423 which extends to the back side direction of the meter from the step portion 422. The step portion 422 is provided with an outer circumferential supporting face 42a (refer to FIG. 2) which faces the back side direction of the meter and supports the outer circumferential edge portion 56 of the substrate 5. In addition, as described later, when fastening the substrate 5 to the lower case 4, the outer circumferential edge portion 56 of the substrate 5 is pressed such that the outer circumferential edge portion 56 of the substrate 5 is inserted into a space 47 of the engagement claw 46. However, the elastic deformation of the substrate 5 is controlled by the contact of the outer circumferential edge portion 56 of the substrate 5 with the outer circumferential supporting face 42a. The outer circumferential supporting face 42a is disposed in the front direction side of the meter slightly closer than the leading end face 44a of the convex portions 44.

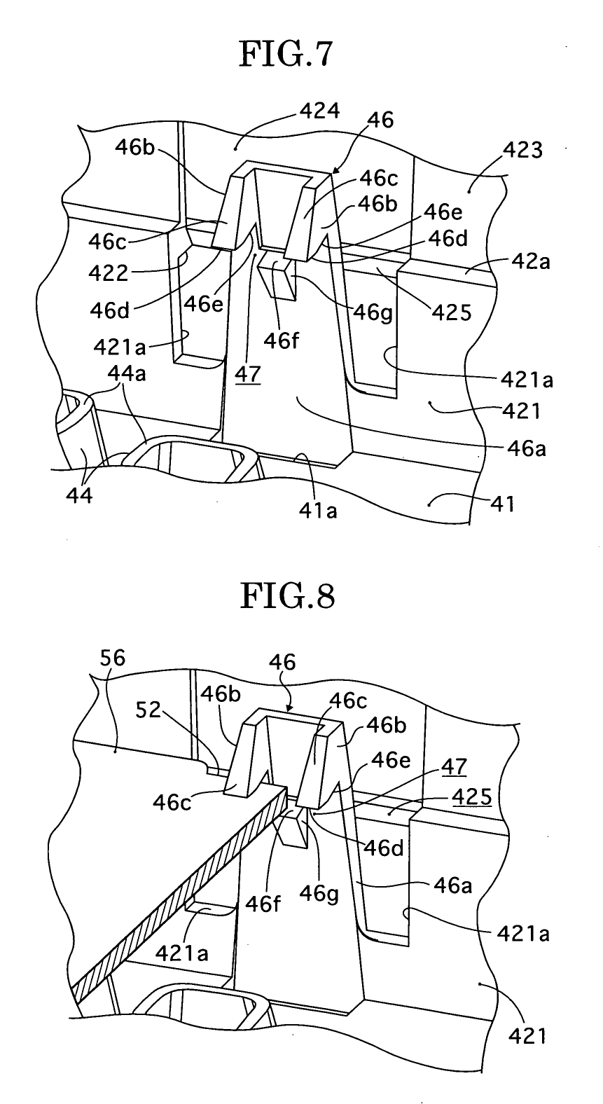

The outer wall base 421 is provided with the above-described engagement claws 46 in the circumferential direction. As illustrated in FIG. 7, each of the engagement claws 46 is integrally formed with the outer wall base 421. Each of the engagement claws 46 includes a raised piece 46a which rises from the outer wall base 421 of the outer wall 42, a pair of claw parts 46b, 46b disposed in the leading end part of the raised piece 46a, and a supporting convex part 46g provided in a position disposed away from the claw parts 46b, 46b in the front direction of the meter.

The raised piece 46a is formed in a thin plate capable of elastically deforming in the outward and inward directions of the lower case 4, and projects in the back side direction of the meter closer than the outer circumferential supporting face 42a. Cutout portions 421a each of which reduces the continuous portion between the raised piece 46a and the outer wall bottom 421, and facilitates the elastic deformation in the outward and inward directions of the lower case 4 are formed on the both sides of the raised piece 46a, respectively, in the circumferential direction of the case. In addition, the outward and inward directions of the lower case 4 are directions orthogonal to the outer wall 42. In FIG. 1, the arrow IN denotes the inward direction of the case, and the arrow OUT denotes the outward direction of the case.

The outer wall leading end portion 423 of the outer wall 42 is provided with expanded portions 424 each having a substantially concave shape as seen from the back side direction of the meter. Each of the expanded portions 424 is formed corresponding to the position where the engagement claw 46 is formed, so as to allow the deformation of the engagement claw 46 in the outward direction of the lower case 4. Each of the positions where the expanded portion 424 is formed is provided with an opening 425 without providing the step portion 422.

As illustrated in FIG. 1, the thickness of the base end portion of the raised piece 46a is reduced. The supporting board 41 is provided with openings 41a each of which is formed corresponding to the base end portion of the raised piece 46a, and allows the elastic deformation of the raised piece 46a in the inward and outward directions of the lower case 4.

The claw part 46b engages with the rear face 5b of the substrate 5, so as to control the movement of the substrate 5 in the back side direction of the meter. As illustrated in FIG. 1, a pair of claw parts 46b, 46b is integrally provided in the both sides of the leading end of the raised edge 46a in the width direction. Each of the claw parts 46b is formed in a beak shape which sharpens in the inward direction of the lower case 4, and includes an inclined guide face 46c, an engaging face 46d, and a concave face 46e.

The inclined guide face 46c is formed in the claw part 46b on the back side (arrow RR) of the meter, and inclines toward the inward side (arrow IN) of the case as approaching the front direction of the meter. In other words, the inclined guide face 46c inclines from the outward direction of the case 4 toward the inward direction of the case 4 in the direction away from the case 4.

The engaging face 46d and the concave face 46e are formed in the claw part 46b on the front side of the meter. The engaging face 46d is disposed on the leading end side of the claw part 46b, and is formed in a direction substantially orthogonal to the front of the meter. In addition, the concave face 46e is formed to follow the engaging face 46d in the outward direction of the case, incline toward the back side of the meter approaching the outward direction of the meter closer than the engaging face 46d, and has a shape which dents in the back side of the meter.

The supporting convex part 46g is positioned away from the engaging face 46d of the claw part 46b in the front of the meter, and is formed in the central position of a pair of claw portions 46b, 46b as seen from the back side of the meter in the circumferential direction of the lower case 4.

The back side of the meter of the supporting convex part 46g is provided with a contact face 46f which has contact with the guide projection 54 of the substrate 5, so as to support the front face 5a of the substrate.

As illustrated in FIG. 1, the contact face 46f and the concave face 46e are substantially parallel, and are formed to incline toward the positions in the back side of the meter illustrated by the arrow RR approaching the outward side of the lower case 4 as illustrated by the arrow OUT. In other words, the contact face 46f and the concave face 46e are formed to incline toward the outward side of the case 4 from the inward side of the case 4 in a direction away from the case 4. In addition, in the embodiment, the inclined angle θ of the contact face 46f and the concave face 46e are about 15°, respectively.

A space 47 into which the outer circumferential edge of the substrate 5 is inserted is formed between the contact face 46f and the claw part 46b. In this space 47, a measurement H1 of an interval between the contact face 46f and the engaging face 46d in the front of the meter, which is the measurement of the entrance of the space 47, is formed such that the rear face 5b and the front face 5a (including the guide projection 54) of the substrate 5 inserted into the space 47 have contact with the engaging face 46d and the contact face 46f, respectively, even if the thickness of the substrate 5 is the minimum thickness of the substrate 5 which is estimated by a manufacturing allowable error. On the other hand, a measurement H2 of an interval between the contact face 46f and the concave face 46e in the orthogonal direction is slightly larger than the maximum thickness of the substrate 5 which is estimated by a manufacturing allowable error.

The projection measurement of the supporting convex part 46g is set within the measurement which overlaps with the concave face 46e in the back side direction of the meter. The engaging face 46d is disposed in the inward side of the case (arrow IN direction) closer than the supporting convex part 46g.

Next, the function of the embodiment will be described.

When fastening the substrate 5 to the lower case 4, at first, the lower case 4 is positioned such that its side in the back side direction (arrow RR direction) of the meter turns up, the front face 5a of the substrate 5 is opposed to the side of the lower case 4, as illustrated in FIG. 4, and then, the substrate 5 is downwardly moved in parallel such that the substrate 5 is disposed inside the outer wall 42 of the lower case 4.

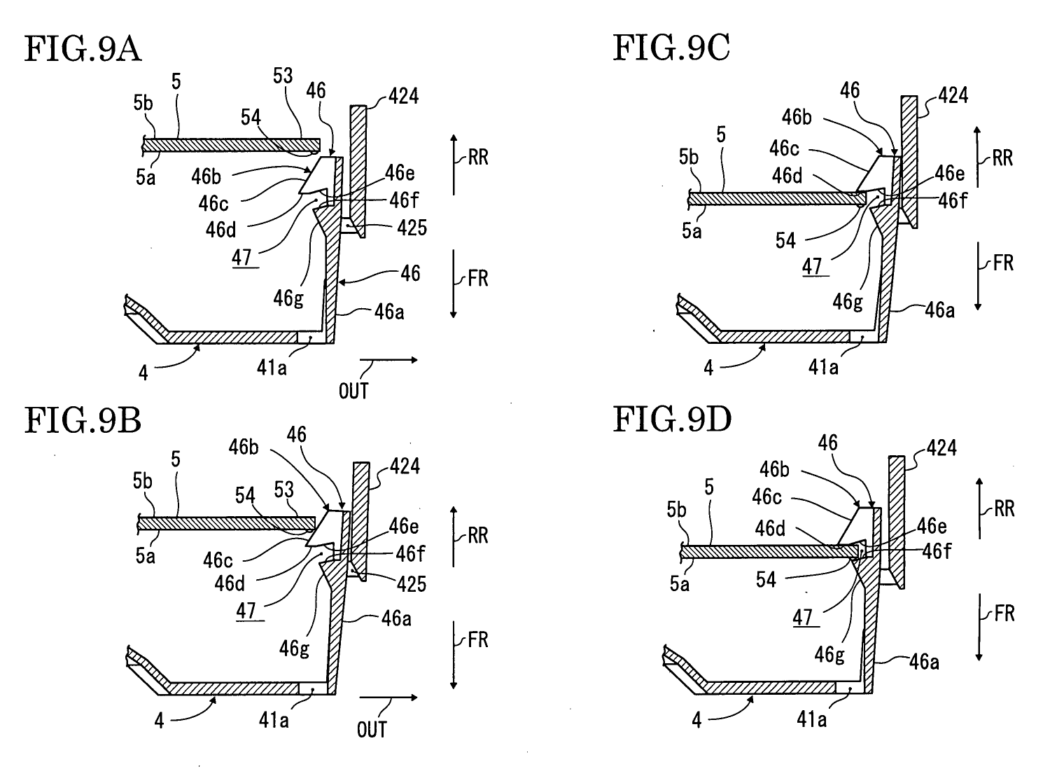

If the substrate 5 is moved to the inside of the leading end portion 423 of the outer wall 42, as illustrated in FIG. 9A, each of the guide projections 45 of the substrate 5 is disposed to overlap with the back side direction of the meter of the inclined guide face 46c of each of the engagement claws 46.

In this state, if the substrate 5 is further moved in the front face direction of the meter, the inclined guide face 46c of the engagement claw 46 is pushed by the guide projection 54 of the substrate 5, and the engagement claw 46 elastically deforms outward of the lower case 4 by the component force functioning on the outward side of the lower case 4 (arrow OUT direction) by the inclination of the inclined guide face 46c as illustrated in FIG. 9B.

In this case, since the cutout parts 421a are formed between both sides of the raised piece 46a of the engagement claw 46 in the width direction and the outer wall base 421 of the outer wall 42, and the space 41a is formed inside the lower case 4 corresponding to the bottom end portion of the raised piece 46a, the raised piece 46a elastically deforms in the outward direction of the lower case 4 in a smooth manner.

In addition, since the guide projection 54 has contact with the inclined guide face 46c, the outer circumferential face of the guide projection 54 is formed in a circular arc shape by solder, and the surface thereof is hard and smooth, the guide projection 54 smoothly moves along the inclined guide face 46c, and the above elastic deformation is smoothly performed.

As described above, when the engagement claw 46 tilts outward of the lower case 4 as illustrated in FIGS. 9B, 9C, the space 47 between the engaging face 46d and the contact face 46f turns up in the clockwise direction in the figures, the measurement H1 of the space 47 in the front and back side directions of the meter increases by the change in the angle, and the measurement H1 approaches the measurement H2 of the interval between the concave face 46e and the inclined guide face 46f.

In this state, by further moving the substrate 5 in the front direction of the meter, the central part of the substrate 5 has contact with the leading end face 44a of the convex portion 44 of the lower case 4 just before the substrate 5 becomes positioned over the claw part 46b of the engagement claw 46. By further pushing the outer circumferential edge portion 56 of the substrate 5 in the front direction of the meter, the substrate 5 becomes positioned over the claw part 46b of the engagement claw 46 as illustrated in FIG. 9C after the substrate 5 is elastically deformed such that the outer circumferential edge portion 56 is disposed in the front direction of the meter closer than the central part. In addition, the further elastic deformation of the substrate 5 is controlled because the outer circumferential edge portion 56 of the substrate 5 has contact with the outer circumferential supporting face 42a as illustrated in FIG. 2.

Accordingly, as illustrated in FIG. 9D, the engagement claw 46 is restored to the original state, and the engaged portion 53 inside the cutout 52 of the substrate 5 is inserted into the space 47 of the engagement claw 46.

Moreover, when the engaged part 53 is inserted into the space 47, the part of the claw part 46b of the engagement claw 46 turns up in the clockwise direction as illustrated FIGS. 9B, 9C, such that the measurement H1 of the space 47 increases. For this reason, the substrate 5 can be effectively inserted into the space 47 even if the thickness of the substrate 5 is the maximum measurement (this measurement is smaller than the measurement H2) within a manufacturing allowable error.

In a state where the engaged portion 53 is inserted into the space 47, as illustrated in FIG. 1, the guide projection 54 of the front face 5a of the substrate 5 has contact with the contact face 46f, and the engaged portion 53 of the rear face 5b of the substrate 5 has contact with the engaging face 46d.

Therefore, the movement of the substrate 5 in the front and back side directions of the meter is controlled, and the substrate 5 is fastened to the lower case 4.

In the substrate 5 fastened state as illustrated in FIGS. 1, 9D, the engagement claw 46 is not completely restored to the original state as illustrated in FIG. 9A, the claw part 46b is slightly lifted, and the leading end of the raised piece 46a slightly tilts outward the lower case 4.

More particularly, by elastically deforming the outer circumferential edge portion 56 of the substrate 5 in the front direction of the meter slightly further than the central portion, the rear face 5b of the substrate 5 has contact with the engaging face 46d without having a space, and the position of the substrate 5 in the back side direction of the meter is controlled.

On the other hand, the positions of the front face 5a of the substrate 5 in the front direction of the meter are different according to the variations of the thickness of the substrate 5. According to the differences of the positions of the front face 5a of the substrate 5, the contact positions with the contact face 46f of the engagement claw 46 are different.

If the thickness of the substrate 5 increases, the contact position of the guide projection 54 becomes closer to the inward side of the lower case 4. Accordingly, the engagement claw 46 elastically deforms outward of the lower case 4. Thereby, the space 47 turns up from the initial state, and thus, the measurement H1 increases from the initial state.

On the other hand, if the thickness of the substrate 5 decreases, the deformation amount of the engagement claw 46 is reduced. Thereby, the measurement H1 of the space 47 approaches the initial value.

In addition, since the inclined guide face 46c and the substrate contact face 46f are formed apart from the raised piece 46a in the inward direction of the lower case, when the substrate 5 has contact with the inclined guide face 46c, and the substrate 5 has contact with the contact face 46f, the large lever ratio of the component force generating toward the outward side of the lower case is secured. For this reason, the engagement claw 46 can be effectively elastically deformed.

Moreover, in the state where the substrate 5 is fastened to the lower case 4 as described above, the outer circumferential edge portion 56 of the substrate 5 has contact with the outer circumferential supporting face 42a of the lower case 4. In this case, even if the substrate 5 has variations in the thickness, the contact convex portion 55 provided in the outer circumferential edge portion 56 of the substrate 5 has point-contact with the outer circumferential supporting face 42a as illustrated in FIG. 2 without having the influence of the variations in the thickness.

Therefore, the entire circumferential of the substrate 5 has uniform contact with the outer-circumferential supporting face 42a without unbalancing the contact state between the substrate 5 and the outer circumferential supporting face 42a. Thus, the looseness between the substrate 5 and the lower case 4 is not caused, and also the pressure by the engagement claw 46 functioning on the substrate 5 can be made entirely uniform.

Moreover, the contact convex portion 55 is formed by solder harder than the resin which forms the lower case 4, so the contact convex portion 55 enters into the outer circumferential supporting face 42a by this pressure.

Thereby, the displacement of the outer circumferential edge portion 56 of the substrate 5 relative to the outer circumferential supporting face 42a in the inward and outward directions of the lower case 4 is controlled, and thus, the looseness of the substrate 5 in the direction along the outer circumferential supporting face 42a can be prevented.

As described above, according to the meter device A of the embodiment, in the engagement claw 46, the contact face 46f is arranged via the space 47 having the measurement H2 larger than the thickness of the substrate 5. Moreover, the contact face 46f inclines, and the engaged portion 53 of the substrate 5 has contact with the engaging faces 46d of the engagement claw 46 and the inclined contact face 46f. Therefore, when the engaged portion 53 of the substrate 5 is inserted into the space 47, the engagement claw 46 elastically deforms according to the thickness of the substrate 5, and also the measurement H1 on the entrance side of the space 47 changes. For this reason, even if the thickness of the substrate 5 has variations due to a manufacturing error, the substrate 5 can effectively be engaged with the engagement claw 46 without having looseness, and also the substrate 5 can be effectively inserted into the space 47 so as to be engaged with the engagement claw 46 without causing an engagement error.

Moreover, in the embodiment, the outer circumferential supporting face 42a is arranged in the front direction of the meter closer than the leading end face 44a of the convex portion 44, and when the substrate 5 is fastened to the lower case 4, the substrate 5 slightly bends. For this reason, the substrate 5 is engaged with the engagement claw 46 by the restoring force, so the looseness of the substrate 5 can be controlled.

Moreover, in the embodiment, since the substrate 5 is provided the guide projection 54 formed by solder in the portion which has contact with the inclined guide face 46 of the engagement claw 46, so the substrate 5 smoothly moves without catching in the inclined guide face 46c. This guide projection 54 is formed in the soldering process such as the circuit of the substrate 5, the guide projection 54 can be formed in a short time and with low costs compared with the projections formed by another grinding process.

In addition, in the embodiment, the supporting convex portion 46g is formed in the raised piece 46a of the engagement claw 46, the contact face 46f is disposed in the inward side of the lower case closer than the outer circumferential supporting face 42a, and the engagement claw 46b projects to the inward of the lower case closer than the supporting convex portion 46g.

Therefore, when inserting the engaged portion 53 of the substrate 5 into the space 47, the working point, which elastically deforms the engagement claw 46 outward of the lower case 4, can be moved away from the raised piece 46a, the lever ratio which generates the elastic deformation can be secured, and the engagement claw 46 can be effectively elastically deformed, resulting in a superior workability.

Moreover, in the embodiment, the concave face 46e which follows the engaging face 46d is formed in the engagement claw 46, and in the claw part 46b, the position away from the engaging face 46d in the outward direction of the lower case 4 does not have contact with the engaged portion 53 of the substrate 5.

Therefore, the measurement H2 in the space 47 of the engagement claw 46 can be secured, and thus, the engaged portion 53 can be effectively and easily inserted into the space 47, and also the lever ratio of the elastic deformation of the above engagement claw 46 can be effectively secured.

Moreover, since the concave face 46e is formed substantially parallel to the contact face 46f, so as to obtain a predetermined measurement H2 of the interval between the contact face 46f and the concave face 46e, when the space 47 is turned up by the elastic deformation of the engagement claw 46 toward the outward side of the lower case 4, the engaged portion 53 of the substrate 5 can be effectively inserted into the back of the space 47. Accordingly, the generation of an engagement error by an inserting error can be prevented.

More particularly, if the engaging face 46d is extended to the position of the concave face 46e, so as to obtain a shape in which the measurement H2 of the space 47 gradually decreases to the outward side of the lower case 4, when the substrate 5 has contact with the engaging face 46d in the position of this concave face 46e by the variations in the thickness of the substrate 5, there may be a case where the above-described large lever ratio can not be obtained, and also the substrate 5 can not be inserted. However, according to the embodiment, such a case can be prevented.

According to the embodiment, the cutout portions 421a are formed on both sides of the raised piece 46a in the width direction, the opening 425, which cuts the outer circumferential supporting face 42a, is formed in the outward side of the lower case of the raised piece 46a, and the opening 41a is formed in the base end portion of the raised piece 46a. Therefore, when assembling the substrate 5 to the lower case 4, the engagement claw 46 can be easily deformed, resulting in an improvement in the workability.

Moreover, according to the embodiment, a pair of engagement parts 46b, 46b is disposed in the leading end of the engagement claw 46, so as to be separated in the width direction of the engagement claw (circumferential direction of case), and the supporting convex part 46g is disposed in the central portion in the width direction of the claw portions 46b, 46b.

Therefore, the engaged portion 53 of the substrate 5 elastically deforms, so as to slightly bend in the circumferential direction, and looseness can be further prevented by the initial load.

As described above, although the present invention has been described in terms of the preferred embodiment and the embodiment, it is not limited thereto. It should be appreciated that variations may be made in the preferred embodiment and the embodiment described by persons skilled in the art without departing from the scope of the present invention.

For example, in the embodiment, the meter device A for use in a vehicle is described, but the meter device A can be applied to a vessel, for example, in addition to a vehicle.

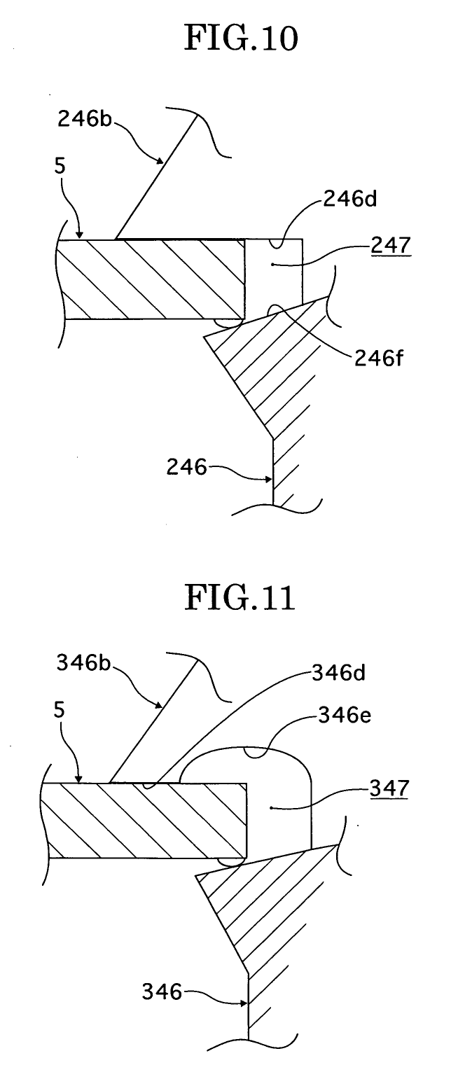

In the embodiment, the example where the concave face 46e as the concave part is formed to follow the engaging face 46d is described. However, the desired effects can be obtained even though such a concave face 46e or concave part is not formed. For example, as an engagement claw 246 illustrated in FIG. 10, even if a substantially horizontal engaging face 246d is formed, according to the thickness in the substrate 5, the engagement claw 246 elastically deforms in the inward and outward directions of the case, and the position that the substrate 5 has contact with a contact face 246f is changed. Therefore, the substrate 5 can be engaged with the engagement claw 246 without having looseness therebetween, and the substrate can be effectively engaged with the engagement claw without causing an engagement error.

Moreover, when forming the concave part, even if a concave part 346e which dents as a circular arc shape as an engagement claw 346 illustrated in FIG. 11 is formed, or a concave part which dents as a rectangular shape is formed, the functions and effects similar to the embodiment can be obtained.

In the embodiment, the inclined angle θ of the contact face 46f is about 15°. However, the inclined angle is not limited thereto as long as the inclination is disposed in the back side direction of the meter (arrow RR direction), which is the raised direction of the engagement claw 46, approaching the outward direction of the lower case 4 (arrow OUT direction). In other words, the inclined angle of the contact face is not limited thereto as long as the contact face 46f inclines toward the outward side of the lower case 4 from the inward side of the lower case 4 in the direction away from the lower case 4.

According to the embodiment, in the engagement claw 46, an example is described where the supporting convex part 46g projects and the contact face 46f is formed on the supporting convex part 46g. However, it is not limited thereto. For example, a part of the engagement claw 46 can be bent, and the contact face can be formed on the bent part.

According to the embodiment, an example where the guide projection 54 is provided in the portion which has contact with the inclined guide face 46c of the engagement claw 46 in the substrate 5 is described. However, it is not limited thereto. For example, a plurality of convex parts each having a spherical face such as the contact convex portion 55 can be formed instead of the guide projection 54 or a process which applies preferable smoothness such as a grinding process can be conducted on the surface of the outer circumferential edge portion 56 of the substrate 5.

In the meter device according to the embodiment of the present invention, when fastening the substrate onto the case, the engagement claw once elastically deforms outward of the case, and the outer circumferential edge portion of the substrate is inserted into the space of the engagement claw before the engagement claw is restored, so that the outer circumferential edge portion of the substrate is sandwiched between the engaging face and the contact face of the claw part of the engagement claw.

In this case, the rear face of the outer circumferential edge portion of the substrate is engaged with the engaging face of the claw part, and the position of the rear face in the back side direction of the meter is determined. In this case, the position of the front face of the substrate in the front direction of the meter differs according to the thickness of the substrate. Moreover, in the engagement claw, the contact face which has contact with the front face of the substrate inclines to be located in the back side direction of the meter whilst approaching the outward side of the case, so by changing the elastic deformation amount of the engagement claw to the outward side of the case according to the position of the front face of the substrate in the front direction of the meter, the contact position with the front face of the substrate can be changed in the inward and outward directions of the case.

More particularly, the contact position of the front face with the contact face becomes the position of the contact face in the inward side of the case as the thickness of the substrate increases. On the other hand, as the thickness of the substrate decreases, the contact position of the front face with the contact face becomes the position of the contact face in the outward side of the case.

As described above, according to the embodiment of the present invention, the engagement claw is provided with the contact face which has contact with the front face of the outer circumferential edge portion of the substrate, in addition to the engaging face which engages with the rear face of the outer circumferential edge portion of the substrate. The contact face inclines to be located in the rising direction of the engagement claw whilst approaching the outward side of the case. Thereby, the elastic deformation state of the engagement claw to the outward side of the case can be changed according to the thickness of the substrate, and the substrate can be always sandwiched between the engaging face and the contact face of the engagement claw.

Accordingly, even if the thickness of the substrate is uneven, the substrate can be effectively engaged with the engagement claw without causing the looseness or an engagement error.

According to the embodiment of the present invention, when fastening the substrate, the contact convex part of the outer circumferential edge portion of the substrate is pressed onto the inclined guide face of the engagement claw. Thereby, the engagement claw once elastically deforms outward of the case by means of the component force by the inclination of the inclined guide face. In this case, the contact convex part has a circular arc face which has point-contact or line-contact with the inclined guide face, so the relative sliding between the contact convex part and the inclined guide face is smoothly conducted.

Then, if the outer circumferential edge portion of the substrate becomes positioned over the inclined guide face of the claw part of the engagement claw, the engagement claw is restored, and the outer circumferential edge portion of the substrate is inserted into the space.

As described above, since the elastic deformation of the engagement claw is conducted by pressing the substrate onto the inclined guide face of the engagement claw, the workability is improved.

Moreover, the substrate is provided with the contact convex part which has point-contact or line-contact with the inclined guide face, and the relative slide is smoothly conducted, so the workability is further improved. In addition, the contact face is inclined by this elastic deformation, so the outer circumferential edge portion of the substrate can be easily inserted, resulting in an improvement in workability.

According to the embodiment of the present invention, since the concave part is formed to follow the engaging face, the interval of the space does not decrease whilst approaching the back side of the insert direction side by the inclination of the contact face, compared with the case which does not have the concave part. Therefore, when inserting the substrate into the space, an insert error by contact of the substrate with the portion of the decreased interval in the back of the space and also an engagement error by the insert error can be prevented.

Furthermore, according to the embodiment of the present invention, the concave part is formed by a face parallel to the contact face, so a constant measurement of the space between the concave part and the contact face can be obtained, and the above insert error can be effectively prevented.

According to the embodiment of the present invention, the edge part of the cutout which is formed in the outer circumferential edge portion of the substrate is inserted into the space of the engagement claw, the rear face of the substrate is engaged with the engaging face of the engagement claw, and the front face of the substrate has contact with the contact face of the substrate.

As described above, since the claw part and the supporting convex part of the engagement claw project inward of the case, the component force functioning on the engagement claw in the outward direction of the case is increased when the substrate has contact with the inclined guide face and the contact face. Therefore, the engagement claw can be elastically deformed.

Moreover, since the cutout is formed in the outer circumferential edge portion of the substrate, and the edge part of the cutout is inserted into the space of the engagement claw, the insert of the substrate into the space can be easily conducted even if the claw part and the supporting convex part largely project inward of the case as described above. Therefore, the workability is improved.

Furthermore, since the contact face and the concave part are disposed to overlap in the inward and outward directions of the case in the concave part, the interval of the space in the front direction of the meter in the position where the contact face is formed does not decrease any smaller than the interval between the contact face and the engaging face in the front direction of the meter. Accordingly, an insert error of the substrate can be effectively prevented.

According to the embodiment of the present invention, when inserting the outer circumferential edge portion of the substrate into the space of the engagement claw, the two points of the rear face of the substrate separated in the circumferential direction of the outer circumferential edge portion are engaged with the engaging face, and the front face of the center of the two points in the circumferential direction has contact with the contact face.

As described above, since the engaging face does not face the contact face in the front direction of the meter, the substrate can be easily inserted, the outer circumferential edge portion of the substrate elastically deforms so as to slightly bend, and thus, looseness can be further prevented by the initial load.

What is claimed is:

1. A meter device, comprising:
a dial having a display design;
a case which is disposed on one side of the dial, and supports the dial;
a substrate which is disposed on a side of the case opposite to the dial, the substrate being provided with an electric component for display driving of the dial;
a plurality of engagement claws each of which is raised toward the substrate from an outer circumferential portion of the case, and is formed to be elastically deformable in inward and outward sides of the case; and
a claw part which projects in an inward direction of the case from a leading end part of the engagement claw, and has an engaging face engaging with an outer circumferential edge portion of the substrate from a side of the substrate opposite to the case side, so as to fasten the substrate to the case, wherein
the engagement claw is provided with a contact face which separates toward the case from the engaging face, so as to form between the engaging face and the contact face a space into which the outer circumferential edge portion of the substrate is insertable, and has contact with the outer circumferential edge portion of the substrate from the case side of the substrate, and
the contact face inclines from the inward side of the case toward the outward side of the case in a direction away from the case.

2. The meter device according to claim 1, wherein
the claw part of the engagement claw is provided with a guide face which inclines from the inward side of the case toward the outward side of the case in the direction away from the case, and
the outer circumferential edge portion of the substrate, which has contact with the guide face when inserting the outer circumferential edge portion of the substrate into the space, is provided with a convex portion which has point-contact with the guide face or has line-contact with the guide face.

3. The meter device according to claim 1, wherein
the claw part of the engagement claw is provided with a concave part which follows the engaging face in the outward of the case, and dents from the inward side of the case toward the outward side of the case in the direction away from the case, and
the concave part is disposed to face the contact face.

4. The meter device according to claim 2, wherein
the claw part of the engagement claw is provided with a concave part which follows the engaging face in the outward direction of the case, and dents in the direction away from the case, and
the concave part is disposed to face the contact face.

5. The meter device according to claim 3, wherein the concave part is formed by a face parallel to the contact face of the substrate.

6. The meter device according to claim 4, wherein the concave part is formed by a face parallel to the contact face of the substrate.

7. The meter device according to claim 3, wherein
the contact face is provided in a supporting convex part which projects inward of the case from the engagement claw, the claw part of the engagement claw projects inward of the case closer than the supporting convex part, and the engaging face is disposed inward of the case closer than the contact face,
a part of the outer circumferential edge portion of the substrate is provided with a cutout which is cut inward of the case from the outer circumferential edge portion, and
an edge part of the cutout is engageable with the engaging face of the engagement claw, and is disposed to be contactable with the contact face.

8. The meter device according to claim 4, wherein
the contact face is provided in a supporting convex part which projects inward of the case from the engagement claw, the claw part of the engagement claw projects inward of the case closer than the supporting convex part, and the engaging face is disposed inward of the case closer than the contact face,
a part of the outer circumferential edge portion of the substrate is provided with a cutout which is cut inward of the case from the outer circumferential edge portion, and
an edge part of the cutout is engageable with the engaging face of the engagement claw, and is disposed to be contactable with the contact face.

9. The meter device according to claim 5, wherein
the contact face is provided in a supporting convex part which projects inward of the case from the engagement claw, the claw part of the engagement claw projects inward of the case closer than the supporting convex part, and the engaging face is disposed inward of the case closer than the contact face,
a part of the outer circumferential edge portion of the substrate is provided with a cutout which is cut inward of the case from the outer circumferential edge portion, and
an edge part of the cutout is engageable with the engaging face of the engagement claw, and is disposed to be contactable with the contact face.

10. The meter device according to claim 6, wherein
the contact face is provided in a supporting convex part which projects inward of the case from the engagement claw, the claw part of the engagement claw projects inward of the case closer than the supporting convex part, and the engaging face is disposed inward of the case closer than the contact face,
a part of the outer circumferential edge portion of the substrate is provided with a cutout which is cut inward of the case from the outer circumferential edge portion, and
an edge part of the cutout is engageable with the engaging face of the engagement claw, and is disposed to be contactable with the contact face.

11. The meter device according to claim 1, wherein
a pair of the claw parts is disposed in each of the engagement claws, the pair of the claw parts being disposed to separate in a circumferential direction of the case, and
the contact face is substantially disposed in a center position of the pair of claw parts in the circumferential direction of the case.
